(19) United States
(12) Patent Application Publication
(10) Pub. No.: US 2012/0226531 A1
(43) Pub. Date: Sep. 6, 2012

(54) ELECTRONIC DEVICE AND METHOD FOR EMBEDDING PRODUCT INFORMATION IN ELECTRONIC MAP WITH PRODUCT PLACEMENTS

(75) Inventors: CHUNG-I LEE, Tu-Cheng (TW); CHIEN-FA YEH, Tu-Cheng (TW); HO-I SUN, Tu-Cheng (TW); YU-FENG CHIEN, Tu-Cheng (TW); SHAN-CHUAN JENG, Tu-Cheng (TW)

(73) Assignee: HON HAI PRECISION INDUSTRY CO., LTD., Tu-Cheng (TW)

(21) Appl. No.: 13/334,098

(22) Filed: Dec. 22, 2011

(30) Foreign Application Priority Data
Mar. 4, 2011 (TW) 100107290

(51) Int. Cl. G06Q 30/02

(52) U.S. Cl. 705/14.4

(57) ABSTRACT

A method embeds product information in certain features in an electronic map using an electronic device. The electronic device receives a selection of a place to display advertising information within the electronic map displayed on a display device, imports street views of the electronic map, and searches for a street view image related to the selected place. When a particular surface or other display area has been selected for embedding the advertising information, the electronic device embeds the advertising information in the display area. When the display area is selected during display, the electronic device reveals the advertising information of the product on the display device.

### BACKGROUND

1. Technical Field

Embodiments of the present disclosure generally relate to devices and methods of advertising displays, and particularly to an electronic device and method for embedding product information in an electronic map with product placements.

2. Description of Related Art

An electronic map is a visual representation of an area, i.e., a symbolic depiction highlighting relationships between elements of that space such as objects, regions, and themes. Particularly, street view images can be viewed on an electronic map by zooming in and by dragging a “pegman” icon onto a location on the electronic map. However, the street view images are static, information fluidity is non-existent or very low. This lack of information renders the electronic map less effective than it could be.

### BRIEF DESCRIPTION OF THE DRAWINGS

FIG. 1 is a block diagram of one embodiment of an electronic device including an information embedding unit.

FIG. 2 is a block diagram of one embodiment of function modules of the information embedding unit of FIG. 1.

FIG. 3 is a flowchart illustrating one embodiment of a method for embedding product information in an electronic map with product placements.

### DETAILED DESCRIPTION

In general, the word “module,” as used herein, refers to logic embodied in hardware or firmware, or to a collection of software instructions, written in a programming language, such as, for example, Java, C, or assembly. One or more software instructions in the modules may be embedded in firmware, such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

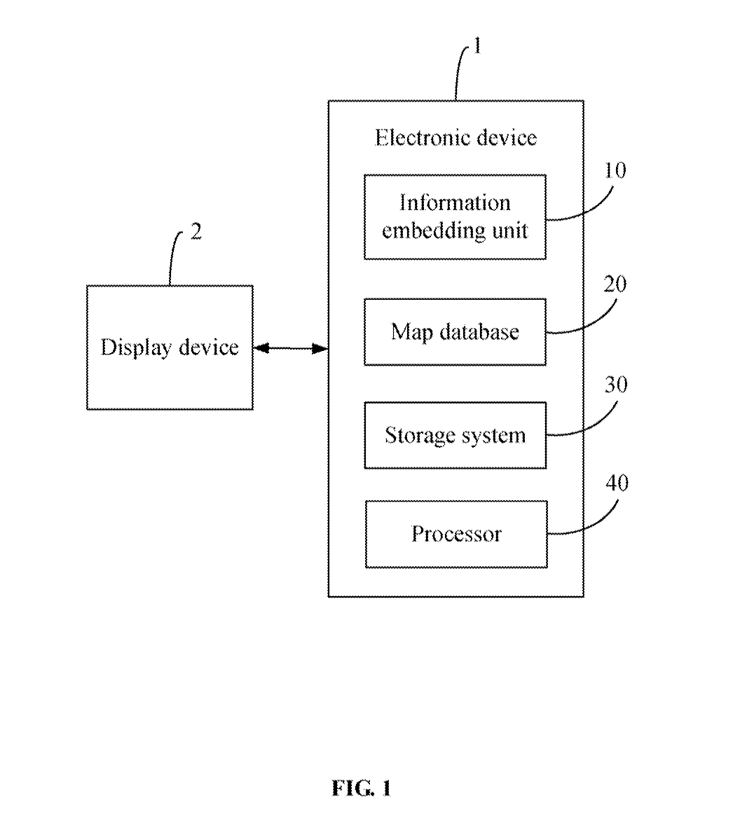

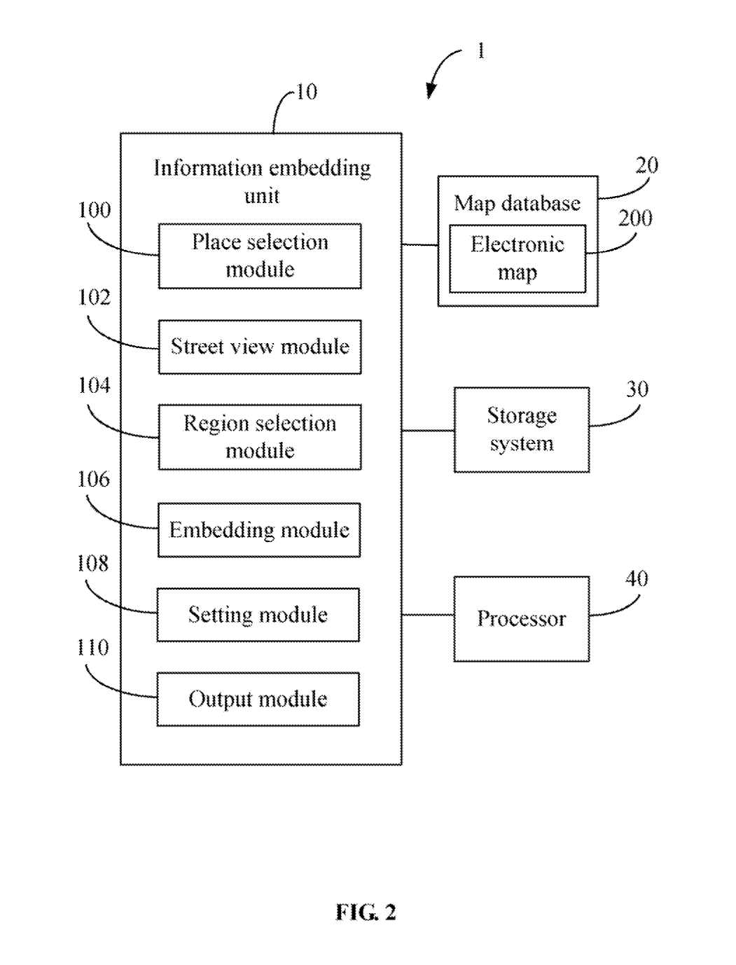

FIG. 1 is a block diagram of one embodiment of an electronic device 1 including an information embedding unit 10. In the embodiment, functions of the embedding unit 10 are implemented by the electronic device 1. The embedding unit 10 can embed advertising information of products in an electronic map 200 (shown in FIG. 2), and display the advertising information integrated with the electronic map 200 on a display device 2 that is electronically connected to the electronic device 1 via a wired or wireless connection. In one embodiment, the products may be cars, watches, or clothes, for example. The products in the advertising information may be presented using, for example, text, audio, advertisement files, Web advertisements, and/or shopping websites. The electronic map 200 includes two map modes: one is a geographical map and another is street view map. The geographic map mode is a mode of the electronic map that displays geographic images/maps, particularly those having a “bird-eye view.” The street view mode is a mode of the electronic map that displays images of a street level view of a particular street or a particular area. The two map modes of the electronic map 200 are stored in a map database 20.

In one embodiment, the electronic device 1 may be a computer, a TV, a portable electronic device, or any other electronic device that includes a storage system 30 and at least one processor 40.

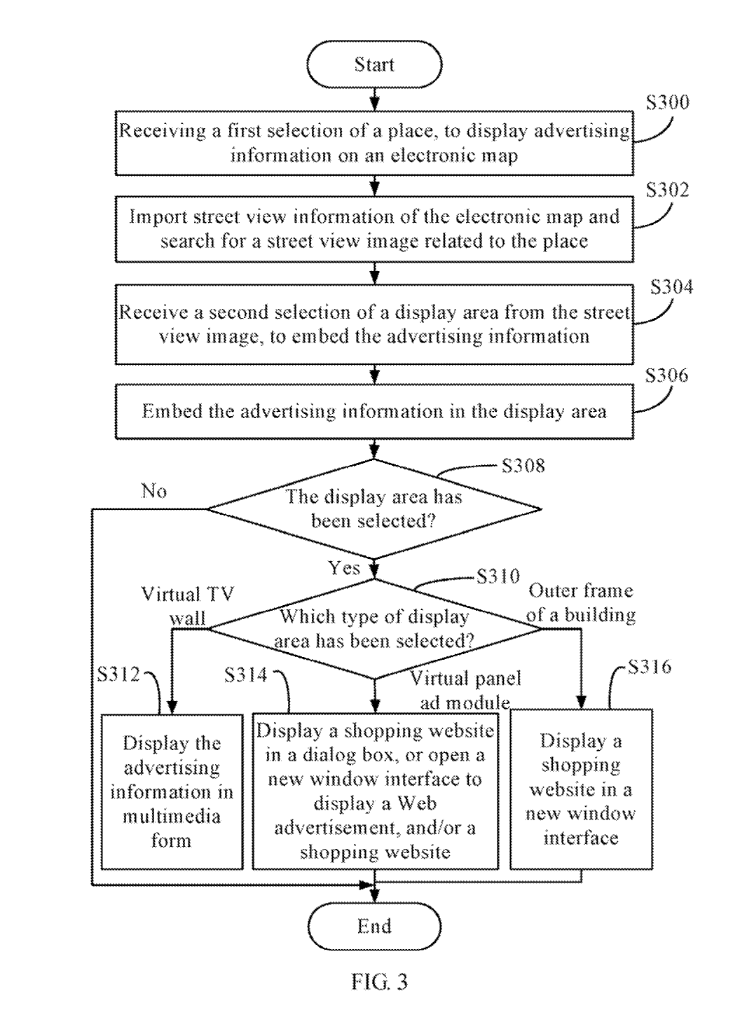

The information embedding unit 10 is configured to embed the advertising information of the products in a selected display area of a street view mode of the map. When the desired display area is selected (via an input device such as a mouse or a touchscreen), the information embedding unit 10 displays the advertising information concurrently with the street view mode on the display device 2. Detail functions of the information embedding unit 10 are described in FIG. 2 and FIG. 3.

The display device 2 is used for displaying the geographical map, the street view map, and the advertising information of the products.

FIG. 2 is a block diagram of one embodiment of function modules of the information embedding unit 10 of FIG. 1. In one embodiment, the information embedding unit 10 includes a place selection module 100, a street view module 102, a region selection module 104, an embedding module 106, a setting module 108, and an output module 110. Each of the modules 100-110 may be a software program including one or more computerized instructions that are stored in the storage system 30 and executed by the processor 40.

In one embodiment, the storage system 30 may be a magnetic or an optical storage system, such as a hard disk drive, an optical drive, or a tape drive. The processor 40 may be a central processing unit including a math co-processor, for example.

When the display device 2 displays the electronic map 20 in the geographical map mode, the place selection module 100 can receive a first selection from a user, via an input device, for a place to display advertising information of a product on the electronic map 200. For example, Love Canal, Kaohsiung of Taiwan may be selected as the place on the map to display the advertising information of the product.

The street view module 102 imports the street view information of the electronic map 200 from the map database 20, and searches for a street view image related to the place. For example, the street view module 102 may search for an image of that location (the Love Canal, Kaohsiung of Taiwan) from the street view information.

The region selection module 104 receives a second selection of a display area from a user on the street view image. The display area is used for embedding the advertising information of the product. In detail, a user uses the region selection module 104 to enclose the display area of the street view image in a drawing box. The drawing box can be a rectangle, a circle, or a box drawn by a user. In the embodiment, a size of the drawing box can be defined by the user. The display area may include a virtual TV wall, a virtual panel ad module, and an outer frame of a building. The virtual TV wall is an actual wall of a building on which the ad is shown by the computer. The virtual panel ad maybe a picture of an ad billboard superimposed on an image of a building.

The embedding module 106 takes the advertising information of the product from an advertisement (ad) database (not shown in FIG. 1 and FIG. 2), and embeds the advertising information of the selected product in the display area.

The setting module 108 sets a duration for displaying the advertising information of the product, such as two minutes or three minutes, for example.

The output module 110 receives a third selection from a user in relation to the display area of the electronic map 200 presented on the display device 2, and reveals the advertising information of the product within the display area on the display device 2 for the set duration.

In the embodiment, if the display area is the virtual TV wall, the output module 110 may display the advertising information in multimedia form. If the display area is the virtual panel ad module, the output module 110 may display a shopping website in a dialog box, or opens a new window interface to display a Web advertisement, and/or a shopping website related to the advertising information. If the display area is the outer frame of the building, the output module 110 may display a shopping website in a new window interface.

FIG. 3 is a flowchart illustrating one embodiment of a method for embedding product information in certain placements within an electronic map 200. Depending on the embodiment, additional blocks may be added, others removed, and the ordering of the blocks may be changed.

In block S300, when the display device 2 displays the electronic map 200 in a geographical map mode, the place selection module 100 receives a first selection from a user, via an input device, for a place to display advertising information of a product on the electronic map 200.

In block S302, the street view module 102 imports street view information of the electronic map 200 from the map database 20, and searches for a street view image related to the place selected.

In block S304, the region selection module 104 receives a second selection of a display area on the street view image from a user. The display area is used for embedding the advertising information of the product. In detail, the user uses the region selection module 104 to enclose the selected display area in a drawing box. In the embodiment, a size of the drawing box can be defined by the user. The display area may include a virtual TV wall, a virtual panel ad module, and an outer frame of a building.

In block S306, the embedding module 106 takes the advertising information of the product from an advertisement database and embeds the advertising information in the display area, and the setting module 108 sets a duration for which the advertising information will be displayed. In the embodiment, the advertising information of the product may include text, audio, advertisement files, Web advertisements, and/or shopping websites. The duration of time can be set as two minutes or three minutes, for example.

In block S308, the output module 110 determines whether the display area has been selected by a viewer. If the display area has been selected by the viewer, block S310 is implemented. Until an advertising is selected by the viewer, the flow pauses at this point.

In block S310, the output module 110 determines which type of display area has been selected. If the display area is the virtual TV wall, block S312 is implemented. If the display area is the virtual panel ad module, block S314 is implemented. If the display area is the outer frame of a building, block S316 is implemented.

In block S312, the output module 110 may display the advertising information in multimedia form.

In block S314, the output module 110 may display a shopping website in a dialog box, or open a new window interface to display a Web advertisement, and/or a shopping website giving the advertising information.

In block S316, the output module 110 may display a shopping website related to the advertising information in a new window interface.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for embedding product information in an electronic map with product placements using an electronic device, the method comprising:
(a) receiving a first selection of a place on an electronic map displayed on a display device, the display device being electronically connected to the electronic device;
(b) importing street view information of the electronic map from a map database and searching for a street view image related to the place from the street view information;
(c) receiving a second selection of a display area from the street view image;
(d) embedding advertising information of the product in the display area, the advertising information selected from an advertisement database; and
(e) receiving a third selection in relation to the display area of the electronic map presented on the display device, and revealing the advertising information of the product within the display area on the display device.

2. The method as described in claim 1, further comprising:
setting a duration for displaying the advertising information of the product.

3. The method as described in claim 1, wherein the display area comprises a virtual TV wall, a virtual panel ad module, and an outer frame of a building.

4. The method as described in claim 3, wherein the block (e) comprises:
upon the condition that the display area is the virtual TV wall, displaying the advertising information in multimedia form on the display device;
upon the condition that the display area is the virtual panel ad module, displaying a shopping website in a dialog box on the display device, or opening a new window interface of the on the display device to display an advertisement, and/or a shopping website related to the advertising information; or
upon the condition that the display area is the outer frame of the building, displaying a shopping website related to the advertising information in a new window interface of the on the display device.

5. The method as described in claim 1, wherein the first selection, the second selection, the third selection are user-inputted.

6. An electronic device, comprising:
at least one processor;
a storage system; and
one or more modules that are stored in the storage system and executed by the at least one processor, the one or more modules comprising:
a place selection module operable to receive a first selection of a place on an electronic map displayed on a display device, the display device being electronically connected to the electronic device;
a street view module operable to import street view information of the electronic map from a map database and search for a street view image related to the place from the street view information;
a region selection module operable to receive a second selection of a display area from the street view image;
an embedding module operable to embed advertising information of the product in the display area, the advertising information selected from an advertisement database; and
an output module operable to receive a third selection in relation to the display area of the electronic map presented on the display device, and reveal the advertising information of the product within the display area on the display device.

7. The electronic device as described in claim 6, further comprising:
a setting module operable to set a duration for displaying the advertising information of the product.

8. The electronic device as described in claim 6, wherein the display area comprises a virtual TV wall, a virtual panel ad module, and an outer frame of a building.

9. The electronic device as described in claim 8, wherein the output module uses follow steps to broadcast the advertising information:
upon the condition that the display area is the virtual TV wall, displaying the advertising information in multimedia form on the display device;
upon the condition that the display area is the virtual panel ad module, displaying a shopping website in a dialog box on the display device, or opening a new window interface of the on the display device to display an advertisement, and/or a shopping website related to the advertising information; or
upon the condition that the display area is the outer frame of the building, displaying a shopping website related to the advertising information in a new window interface of the on the display device.

10. The electronic device as described in claim 6, wherein the first selection, the second selection, the third selection are user-inputted.

11. A non-transitory storage medium having stored thereon instructions that, when executed by a processor of an electronic device, causes the processor to perform a method for embedding product information in an electronic map with product placements, the method comprising:
(a) receiving a first selection of a place on an electronic map displayed on a display device, the display device being electronically connected to the electronic device;
(b) importing street view information of the electronic map from a map database and searching for a street view image related to the place from the street view information;
(c) receiving a second selection of a display area from the street view image;
(d) embedding advertising information of the product in the display area, the advertising information selected from an advertisement database; and
(e) receiving a third selection in relation to the display area of the electronic map presented on the display device, and revealing the advertising information of the product within the display area on the display device.

12. The storage medium as described in claim 11, wherein the method further comprises:
setting a duration for displaying the advertising information of the product.

13. The storage medium as described in claim 11, wherein the display area comprises a virtual TV wall, a virtual panel ad module, and an outer frame of a building.

14. The storage medium as described in claim 13, wherein the block (e) comprises:
upon the condition that the display area is the virtual TV wall, displaying the advertising information in multimedia form on the display device;
upon the condition that the display area is the virtual panel ad module, displaying a shopping website in a dialog box on the display device, or opening a new window interface of the on the display device to display an advertisement, and/or a shopping website related to the advertising information; or
upon the condition that the display area is the outer frame of the building, displaying a shopping website related to the advertising information in a new window interface of the on the display device.

15. The storage medium as described in claim 11, wherein the first selection, the second selection, the third selection are user-inputted.
